(19) United States
(12) Patent Application Publication
(10) Pub. No.: US 2007/0124599 A1
(43) Pub. Date: May 31, 2007

(54) Authentication apparatus and method for use in vehicle

(75) Inventors: Hideki Morita, Kobe (JP); Hirofumi Takasuka, Kobe (JP)

Correspondence Address: OLIFF & BERRIDGE, PLC, P.O. BOX 19928, ALEXANDRIA, VA, 22320, US

(73) Assignee: FUJITSU TEN LIMITED, HYOGO (JP)

(21) Appl. No.: 11/598,049

(22) Filed: Nov. 13, 2006

(30) Foreign Application Priority Data
Nov. 28, 2005 (JP) 2005-342969

(51) Int. Cl. G06F 12/14; H04K 1/00; G06F 17/30; G06F 12/00; H04L 9/00; G06F 13/00; G06F 7/04; G06F 7/58; G06K 19/00; G11C 7/00; H04L 9/32

(52) U.S. Cl. 713/186; 726/17; 726/19

(57) ABSTRACT

An authentication method for use in a vehicle includes identifying validity by use of identification information stored, detecting an unauthorized use risk level predicted by a state of a vehicle, changing an authentication level according to an identification result and the unauthorized use risk level at the time of processing a biometric authentication, calculating a matching level between first biometric characteristic information of a vehicle passenger and second biometric characteristic information stored, and comparing the matching level calculated and an authentication level to output an authentication result at the time of processing the biometric authentication.

### BACKGROUND OF THE INVENTION

1. Field of the Invention

This invention generally relates to authentication technique suitable for the prevention of vehicle robbery and theft.

2. Description of the Related Art

Various antitheft devices have conventionally been proposed to prevent the robbery and theft of vehicles. For example, there have been known an electronic key equipped with an immobilizer (electronic anti-theft device) and an authentication device by use of biometric information, as disclosed in Japanese Patent Application Publication No. 2004-272501. The authentication by use of biometric information is a system by which a personal authentication is done on the basis of human physical traits of a user, namely, biological information such as fingerprint, iris, or the like.

In the electronic key equipped with the immobilizer, however, if the electronic key is lost and such lost electronic key is obtained by a malicious third party, there is the possibility that the vehicle is stolen with ease. In addition, in the authentication device with the use of the biometric information, there are drawbacks in that the authentication speed is low and the authentication rate is low. Japanese Patent Application Publication No. 2003-248661 discloses a technique of changing the threshold value according to the authentication level.

It is to be noted that a vehicle is not always parked at the same parking space. In some cases, the vehicle has to be parked at a place where there is a high possibility of robbery or theft, whereas in some cases, the vehicle can be parked at a safe place. If a given authentication level is always set in both cases, it takes excessive time for authentication and it may increase the possibility of robbery or theft after all.

If a user commutes driving by car, the time to start working is almost the same and the time to get on the vehicle is determined accordingly. If the same authentication level is always set in even such a case, it also takes excessive time for authentication.

### SUMMARY OF THE INVENTION

The present invention has been made in view of the above circumstances and provides an authentication apparatus and method for use in a vehicle, by which an authentication level can be set appropriately according to a use state or a state in which an authentication is done such as a parked location.

According to one aspect of the present invention, there is provided an authentication method for use in a vehicle including: identifying validity by use of identification information stored; detecting an unauthorized use risk level predicted by a state of a vehicle; and changing an authentication level according to an identification result and the unauthorized use risk level at the time of processing a biometric authentication; calculating a matching level between first biometric characteristic information of a vehicle passenger and second biometric characteristic information stored; and comparing the matching level calculated and an authentication level to output an authentication result at the time of processing the biometric authentication.

According to another aspect of the present invention, there is provided an authentication apparatus for use in a vehicle including: an identifying portion that identifies validity by use of identification information stored in a memory portion; an unauthorized use risk level detecting portion that detects an unauthorized use risk level predicted by a state of a vehicle; an authentication level changing portion that changes an authentication level according to an identification result of the identifying portion and the unauthorized use risk level detected by the unauthorized use risk level detecting portion at the time of processing a biometric authentication; a matching level calculating portion that calculates a matching level between first biometric characteristic information of a vehicle passenger and second biometric characteristic information stored in the memory portion; and a comparing portion that compares the matching level calculated by the matching level calculating portion and the authentication level to output an authentication result.

The authentication level is changed according to the risk level at which the vehicle is used by an unauthorized third party, making it possible to heighten the authentication level as the risk level is increased and shortening the time for authentication.

### BRIEF DESCRIPTION OF THE DRAWINGS

Preferred exemplary embodiments of the present invention will be described in detail with reference to the following drawings, wherein:

FIG. 1 shows a configuration of an authentication apparatus for use in vehicle in accordance with a first exemplary embodiment of the present invention;

FIG. 2 shows similarity levels, false rejection rate (FRR), and false acceptance rate (FAR);

FIG. 3 is a flowchart of procedure in accordance with a first exemplary embodiment of the present invention;

FIG. 4 is a flowchart of procedure in accordance with a second exemplary embodiment of the present invention;

FIG. 5 is a flowchart of procedure in accordance with a third exemplary embodiment of the present invention;

FIG. 6 is a flowchart of procedure in accordance with a fourth exemplary embodiment of the present invention;

FIG. 7 is a flowchart of procedure in accordance with a fifth exemplary embodiment of the present invention;

FIG. 8 is a flowchart of procedure in accordance with a sixth exemplary embodiment of the present invention;

FIG. 9 is a flowchart of procedure in accordance with a seventh exemplary embodiment of the present invention;

FIG. 10 shows an example in which the authentication level of the second biometric authentication is changed in accordance with the matching rate of the first biometric authentication; and

FIG. 11 is a flowchart of procedure in accordance with an eighth exemplary embodiment of the present invention.

### DESCRIPTION OF THE PREFERRED EMBODIMENTS

A description will now be given, with reference to the accompanying drawings, of exemplary embodiments of the present invention.

### First Exemplary Embodiment

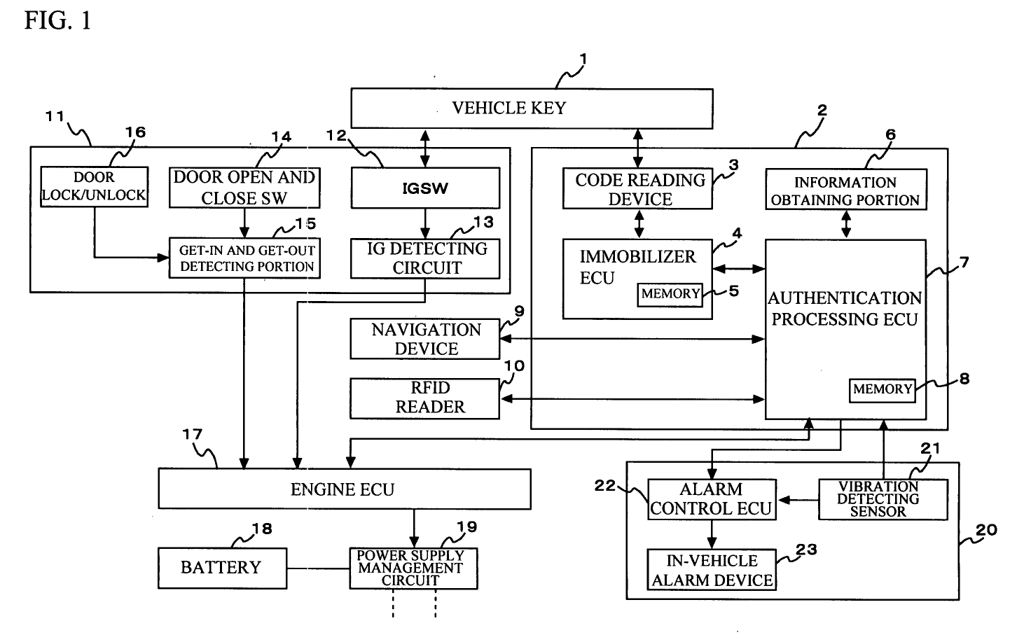

Referring now to FIG. 1, a description will be given of a configuration of an authentication apparatus for use in vehicle in accordance with a first exemplary embodiment of the present invention. The authentication apparatus for use in vehicle employed in the first exemplary embodiment of the present invention includes: a vehicle key 1; an authentication device 2; a navigation device 9 serving as an unauthorized use risk level detecting portion; an RFID reader 10 also serving as the unauthorized use risk level detecting portion; get-in and get-out detecting portion 11 also serving as the unauthorized use risk level detecting portion; an engine ECU 17; a battery 18; a power supply management circuit 19; and an alarm device 20.

The authentication device 2 is provided with a code reading device 3; an immobilizer ECU 4 serving as the unauthorized use risk level detecting portion and also serving as an identifying portion; a biometric authentication information obtaining portion 6 serving as biometric information reading portion; and an authentication processing ECU 7 serving as a matching level calculating portion, a comparing portion, and an authentication level changing portion. The biometric authentication information obtaining portion 6 may be installed inside the vehicle, or may be installed outside thereof. The get-in and get-off detecting portion 11 is provided with: an ignition switch 12 (hereinafter, simply referred to as IGSW); an ignition detecting circuit 13 (hereinafter, simply referred to as IG detecting circuit); a door open and close switch 14 (hereinafter, simply referred to as door open/close SW); a get-in and get-out detecting circuit 15; and a door lock/unlock detecting circuit 16. The alarm device 20 is provided with: a vibration detecting sensor 21; an alarm control ECU 22; and an in-vehicle alarm device 23.

An ID code for key identification is stored in the vehicle key 1. The immobilizer ECU 4 is a control unit composed of: a known CPU; and a memory 5 of ROM, RAM, EEPROM, or the like, and the immobilizer ECU 4 is connected to the code reading device 3. When the vehicle key 1 is inserted into the key slot, the code reading device 3 reads the ID code stored in the vehicle key 1 and transmits the ID code to the immobilizer ECU 4.

The immobilizer ECU 4 verifies such obtained ID code and the ID code stored in the memory 5. If they are matched, an identification completion signal indicative of identification success. If they are not successful, an identification failure signal is output to the authentication processing ECU 7. The immobilizer ECU 4 retains the information that such obtained ID code is matched with the ID code stored in the memory 5.

The biometric authentication information obtaining portion 6 is configured to be able to obtain one or more pieces of biometric authentication information. The biometric authentication information obtaining portion 6 may, for example, includes: hardware such as a fingerprint sensor that can obtain fingerprint information, a camera that can obtain face information, or the like; and application software that obtains the fingerprint information or the face information while controlling the above-described hardware to perform an extracting process on such obtained the biometric authentication information according to a given algorithm.

The authentication processing ECU 7 is a control unit composed of: a known CPU; and a memory 8 serving as a memory portion of ROM, RAM, EEPROM, or the like, and the authentication processing ECU 7 performs a biometric characteristic extracting process and an authentication process. The biometric characteristic extracting process employs an image processing or analysis process suitable for the type of authentication to extract the biometric characteristic. In the authentication process, such extracted biometric characteristic data is compared with the biometric characteristic data of a user registered in a personal authentication database (built in the memory 8) to perform a user authentication.

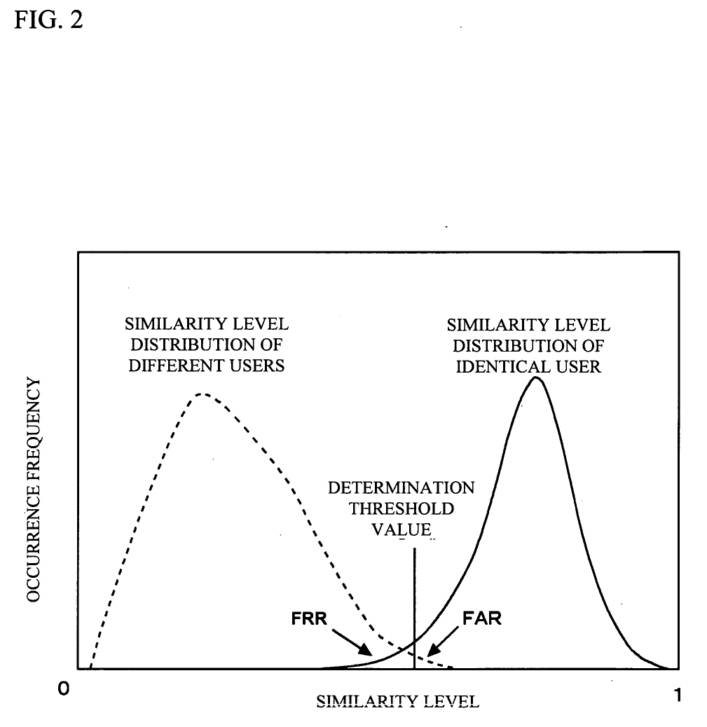

FIG. 2 shows a similarity level in which pieces of the biometric characteristic data of an identical user are compared and another similarity level in which the pieces of the biometric characteristic data of different users are compared. As shown in FIG. 2, 1 is a similarity level of complete matching between the pieces of the biometric characteristic data of the identical user, whereas there is a peak close to 0 in the similarity level between different users. It is ideal that both distributions are completely separate. In the actual biometric characteristic data, however, bottoms of the distributions partially overlap each other. For this reason, the false rejection rate (FRR) and the false acceptance rate (FAR) are set to determine the threshold value of the similarity level according to the importance levels of FRR and FAR, FRR being the percentage of times that an authorized user is falsely rejected, FAR being the percentage of times that a non-authorized user is falsely accepted.

The navigation device 9 detects the current location of the vehicle, and displays maps around the current location, so as to guide the user to the destination. Also, the navigation device 9 is provided with: a GPS receiver that receives multiple electric waves transmitted from multiple GPS satellites and performs a measuring process to learn the absolute location of the vehicle; and an independent navigation sensor that measures the relative location of the vehicle by use of multiple sensors mounted in the vehicle. With the above-described information, the navigation device 9 specifies the current location.

The RFID reader 10 performs wireless communication with an RFID tag carried by a vehicle passenger, and retrieves authentication information stored in the RFID tag to output to the authentication processing ECU 7. The authentication processing ECU 7 compares the authentication information retrieved from the RFID tag and that registered in the memory 8 in advance for authentication.

Next, the get-in and get-out detecting portion 11 will be described. The IGSW 12 has multiple switching positions such as off state, ignition-on state, starter-on state, and the like, as a use state of the vehicle, so that the passenger of the vehicle can perform the switching operations thereof. The IG detecting circuit 13 detects the state of the IGSW 12, and supplies the information thereof to the engine ECU 17. The engine ECU 17 detects the state of the IGSW 12 on the basis of the information supplied from the IG detecting circuit 13.

The door open/close SW 14 is composed of courtesy switches respectively provided in doors of the vehicle, and outputs signals to the get-in and get-out detecting circuit 15 according to the open and close state of the door of the vehicle. The door lock/unlock detecting circuit 16 detects remote door lock/unlock operation by means of the wireless communication between a portable device carried by the vehicle passenger outside the vehicle and an in-vehicle device to learn whether the door is locked or unlocked. Also, the door lock/unlock detecting circuit 16 detects whether all the doors are locked or any of the doors is unlocked according to the mechanical lock/unlock operation of the vehicle key inserted into the door key cylinder provided in the vehicle door, and outputs the information to the get-in and get-out detecting circuit 15. The get-in and get-out detecting circuit 15 detects the state of the vehicle door on the basis of the signals fed from the door open/close SW 14, and also detects the door lock/unlock state of the vehicle door on the basis of the information supplied from door lock/unlock detecting circuit 16. Then, according to the above-described detection results, it is detected that the vehicle passenger is getting in or getting out of the vehicle.

Upon receiving an authentication success notification from the authentication processing ECU 7, the engine ECU 17 controls the power supply management circuit 19 to supply power of the battery 18 to the ignition device, the fuel injection device, the starter, and the like. By the afore-described operations, the engine ECU 17 controls the ignition of the engine, the amount of fuel consumption, and the like.

Next, the alarm device 20 will be described. The vibration detecting sensor 21 detects the vibration of the vehicle to function as a theft sensor. The vibration detecting sensor 21 may employ, for example, an acceleration sensor. When the vibration detecting sensor 21 detects the vibration of the vehicle or when the authentication processing ECU 7 recognizes an authentication failure, the alarm control ECU 22 controls the in-vehicle alarm device 23 to output an alarm.

The authentication apparatus for use in vehicle with the above-described configuration employed in the present exemplary embodiment predicts the unauthorized use risk level such as a theft according to a parked state of the vehicle, and changes the authentication level according to such predicted unauthorized use risk level. Here, the unauthorized use risk level indicates the possibility of unauthorized use, and can be predicted with the elements that influence hours or period of time, district, elapsed time since the user gets out of the vehicle, ease of unauthorized use (crime rate).

In the first exemplary embodiment, the vehicle passenger inputs scheduled get-in time or get-in hours of the day from an operating portion or the like of the navigation device 9 so that the authentication level can be lowered in such registered scheduled get-in time of the day. This can reduce the burden on the authentication operation and reduce the period of time necessary for authentication. By setting the authentication level high in the hours except the scheduled get-in time of the day, a user is able to park the vehicle with a sense of security. In addition to the scheduled get-in time of the day, it is possible to set a specific date, period, day of the week, and it is also possible to change the authentication level according to such settings. Hereinafter, “time” generally denotes hours, date, period, day of the week, and the like.

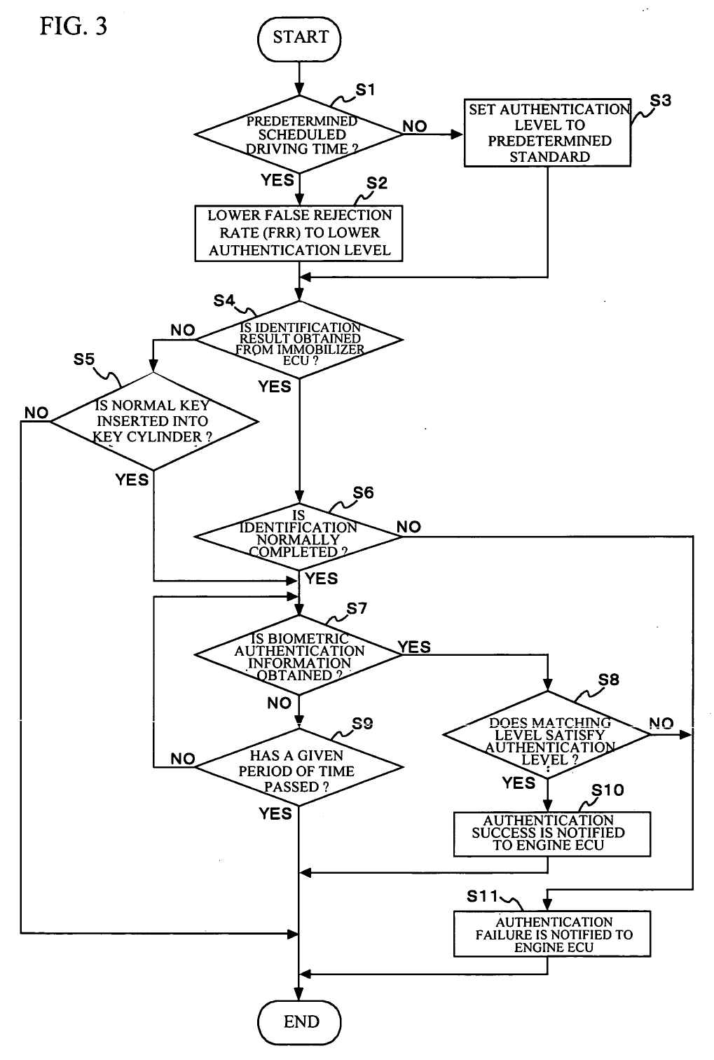

A description will now be given, with reference to FIG. 3, of the procedure of the authentication apparatus for use in vehicle employed in the present exemplary embodiment. If it is the predetermined scheduled get-in time of the day (step S1/YES), the authentication processing ECU 7 lowers the false rejection rate (FRR) to lower the authentication level (step S2). The scheduled get-in time of the day may be input by a user from, for example, the operating portion of the navigation device 9. Such input scheduled driving period are sent from the navigation device 9 to the authentication processing ECU 7 and stored in the memory 8 of the authentication processing ECU 7. If it is not the scheduled get-in time of the day (step S1/NO), the authentication level is set to the predetermined standard level (step S3). Then, the authentication processing ECU 7 waits for the identification result supplied from the immobilizer ECU 4, that is, the identification result of whether or not the identification is successful (step S4). If the identification result is supplied from the immobilizer ECU 4 (step S4/YES), the authentication processing ECU 7 determines whether or not the identification is normally, namely, successfully completed. If the identification is not normally completed (step S6/NO), the authentication processing ECU 7 notifies a identification failure to the engine ECU 17 (step S11), and ends the procedure.

The authentication apparatus for use in vehicle employed in the present exemplary embodiment may be activated by a trigger, for example, when a passenger gets in the vehicle, and starts the procedure shown in FIG. 3. The determination of whether or not the passenger gets in the vehicle may be made when a passenger detecting sensor or the like detects that the passenger sits on a seat, after the vehicle door is unlocked.

If the identification is normally completed (step S6/YES), the authentication processing ECU 7 determines whether or not the biometric characteristic data of a passenger is supplied from the biometric authentication information obtaining portion 6 (step S7). If the biometric characteristic data is supplied (step S7/YES), the authentication processing ECU 7 compares such supplied biometric characteristic data with the biometric characteristic data registered in the memory 8 in advance, and calculates the matching level between the both biometric characteristic data. In other words, it is determined that the matching level satisfies the authentication level set at step S2 or step S3. If the matching level that satisfies the authentication level is obtained in the biometric authentication (step S8/YES), the authentication processing ECU 7 notifies the authentication success to the engine ECU 17 (step S10). If the identification result is not supplied from the immobilizer ECU 4 (step S4/NO), it is determined whether or not a normal key not equipped with the immobilization function is inserted into the key cylinder (step S5). If the normal key is inserted (step S5/YES), processing goes to step S7. If the normal key is not inserted (step S5/NO), processing ends.

Until a given period of time has passed since the identification result was supplied from the immobilizer ECU 4, the biometric information is tried to be obtained (step S9/NO). If the biometric characteristic data cannot be obtained from the biometric authentication information obtaining portion 6, even after a given period of time has passed (step S9/YES), processing ends.

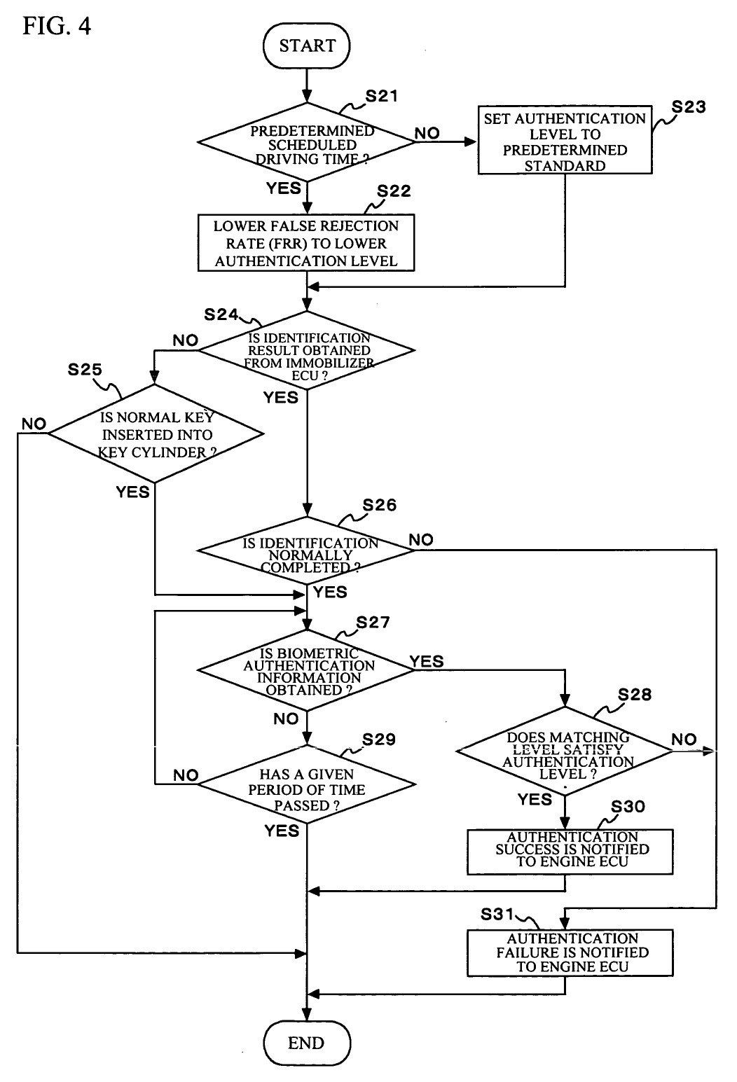

In the flowchart of FIG. 3, the authentication level is lowered by lowering the false rejection rate (FRR). Referring now to FIG. 4, if it is the scheduled get-in time of the day (step S21/YES), the false acceptance rate (FAR) may be lowered (step S22) to raise the authentication level. For example, through the night and into the morning, there is a low possibility of getting in the vehicle, but there is the possibility of theft. For these reasons, the hours in which a passenger does not get in the vehicle are set, so the false acceptance rate (FAR) is set low and the authentication level is raised in the hours. In the examples shown in FIG. 3 and FIG. 4, the descriptions have been given of the case where the scheduled get-in time of the day is designated to change the authentication level. If a user gets in the vehicle on a specific day of the week, however, it is possible to designate the day of the week when the user gets in the vehicle. According to the present exemplary embodiment, a description has been given of a case where the above-described processing starts at the time when a passenger gets in the vehicle, as a trigger. However, if the biometric authentication information obtaining portion 6 is provided outside of the vehicle, for example, at a door handle portion or the like, the above-described processing may start when a smart key system or the like detects that someone is approaching the vehicle.

### Second Exemplary Embodiment

A second exemplary embodiment of the present invention will be described with reference to accompanying drawings. In the present exemplary embodiment, the information of the authentication performed by the authentication processing ECU 7 such as the day of the week or the time of the day is stored in the memory 8 as a log, the day of the week or the time of the day of a high get-in frequency is determined by the authentication processing ECU 7, and the authentication level is automatically changed. In the second and later exemplary embodiments of the present invention, the same components and configurations as those employed in the first exemplary embodiment have the same reference numerals and a detailed explanation will be omitted.

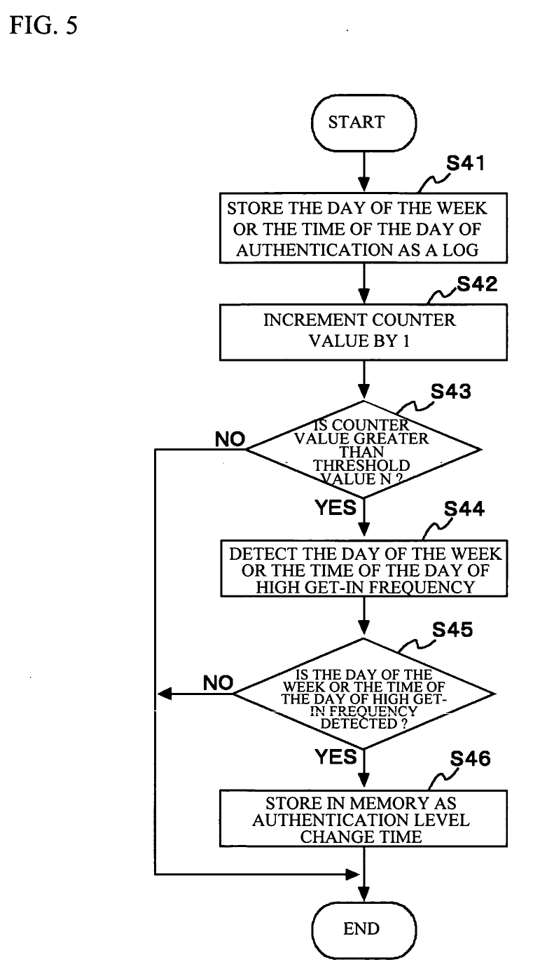

A description will be given, with reference to FIG. 5, of the procedure employed in the present exemplary embodiment. The authentication processing ECU 7 implements the following processes, every time the authentication is performed. The information of the authentication performed such as the time of the day or the day of the week is stored in the memory 8 as a log (step S41). Next, the counter value is incremented by 1 (step S42). The counter is provided to count the number of pieces of data stored in the memory 8 as logs. Then, the authentication processing ECU 7 compares the counter value and a threshold value N (step S43). The threshold N is an arbitrary natural number, and may be changed by a user's need. If the counter value is greater than the threshold value N (step S43/YES), the authentication processing ECU 7 detects the day of the week or the time of the day of a high get-in frequency from the log information stored in the memory 8 (step S44). If the day of the week or the time of the day of a high get-in frequency can be detected from the log information (step S45/YES), such detected day of the week or the time of the day is stored in the memory 8 as an authentication level change time. If the counted value of the counter is not greater than the threshold value N (step S43/NO), or if the day of the week or the time of the day of a high get-in frequency cannot be detected (step S45/NO), processing ends. Processing starts when the authentication processing ECU 7 performs the authentication next time. From this point, the authentication processing ECU 7 sets the authentication level to low at the authentication level change time, so that the passenger can get in the vehicle without taking plenty of time for authentication. In the above-described process flow, the authentication level is set low by detecting the day of the week or the time of the day of a high authentication frequency. In contrast, however, the authentication level may be set high, by detecting the day of the week or the time of the day of a low authentication frequency.

### Third Exemplary Embodiment

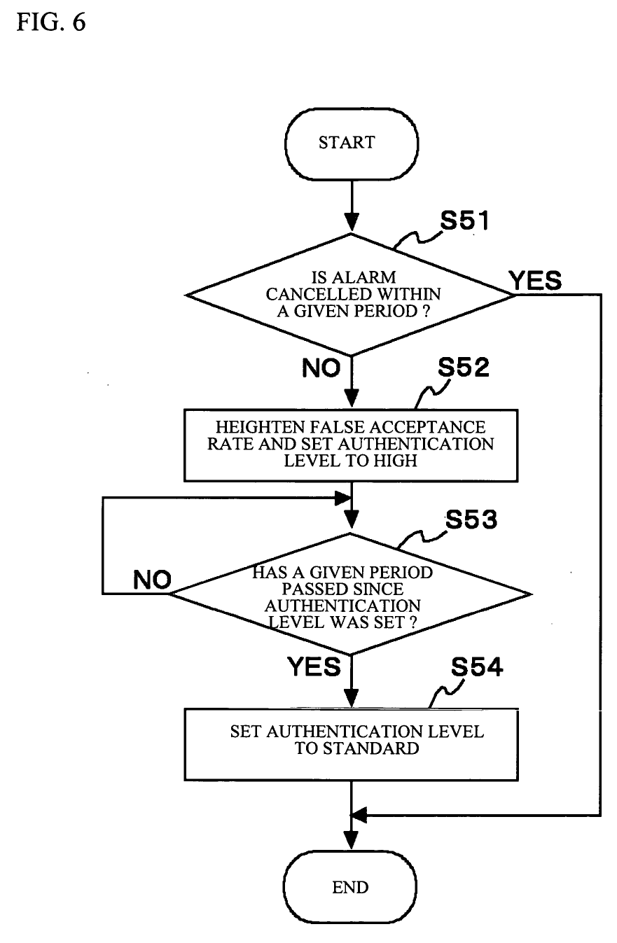

A third exemplary embodiment of the present invention will be described with reference to accompanying drawings. In the present exemplary embodiment, after the alarm device is operated, the authentication level is heightened to enhance the security. FIG. 6 is a flowchart of the procedure in accordance with the third exemplary embodiment of the present invention. The authentication apparatus used for vehicle employed if the present exemplary embodiment starts the following processing when an in-vehicle alarm device is operated. The in-vehicle alarm device is operated, for example, when the vibration detecting sensor 21 detects that the parked vehicle is vibrated. The parked vehicle is vibrated and the vibration detecting sensor 21 detects the vibration. When the in-vehicle alarm device 23 outputs an alarming sound by means of the control of the alarm control ECU 22, the following processes start. If the alarm is not cancelled by the operation of the vehicle key 1 or the like within a given period of time after the alarming sound output (step S51/NO), the authentication processing ECU 7 lowers the false acceptance rate (FAR) and sets the authentication level to high (step S52). If there is no vehicle key operation, it can be imagined that a third party other than the owner of the vehicle is forcibly breaking a door open. If this happens, it is possible to avoid the risk of a theft by lowering the false acceptance rate (FAR) and setting the authentication level high. If a given period of time has passed since the authentication level was set to high (step S53/YES), it is determined that the risk of the theft conducted by a third party was successfully prevented. Then, the authentication level is set back to the standard level (step S54) and processing ends. If the alarm is cancelled within a given period of time (step S51/YES), processing ends. If a given period of time has not passed since the authentication level was set (step S53/NO), processing goes back to step S53.

### Fourth Exemplary Embodiment

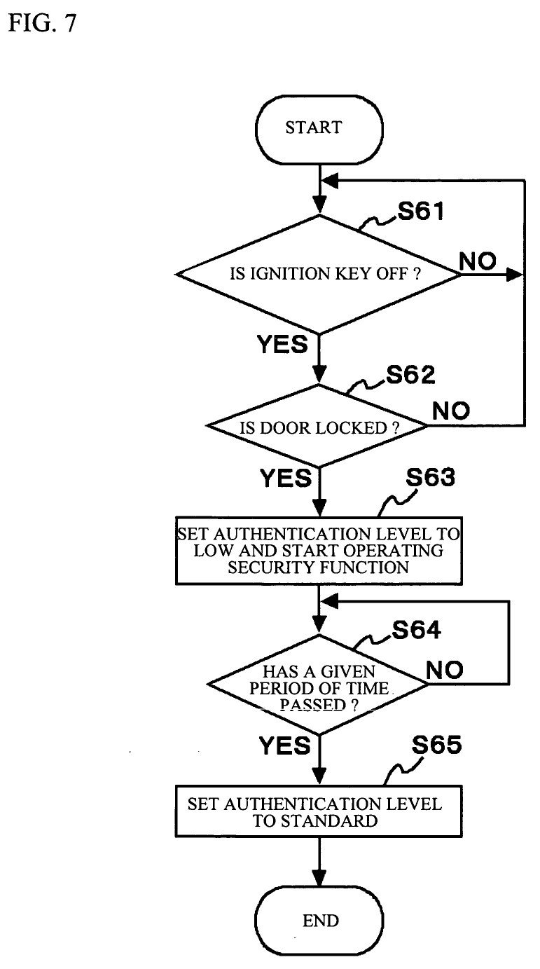

A fourth exemplary embodiment of the present invention will be described with reference to accompanying drawings. In the present exemplary embodiment, the authentication level is set to low for an easy authentication within a given period of time after the passenger gets out of the vehicle Immediately after the passenger gets out of the vehicle, in most cases, the passenger returns to the vehicle and gets on the vehicle again within a short period of time, for example, if the passenger forgets something in the vehicle or after the passenger finishes some simple errands. Accordingly, the authentication level is set to low so as to shorten the time for authentication. FIG. 7 is a flowchart of the procedure in accordance with the fourth exemplary embodiment of the present invention. The in-vehicle authentication apparatus employed in the present exemplary embodiment implements the following processes when a passenger is getting out of a vehicle, for example, the vehicle stops and the door thereof is unlocked. When the IG detecting circuit 13 detects that the ignition key turns off (step S61/YES) and the get-in and get-out detecting circuit 15 detects that the door is locked (step S62/YES), it is determined that the passenger gets out of the vehicle. The engine ECU 17 determines that the passenger gets out of the vehicle, and outputs a given signal to the authentication processing ECU 7 to notify thereto.

If a given signal is input from the engine ECU 17 to the authentication processing ECU 7, the authentication processing ECU 7 sets the authentication level to low to start operating the security function (step S63). Subsequently, the authentication processing ECU 7 waits for an input of the authentication information from the immobilizer ECU 4 and that of the biometric characteristic data from the biometric authentication information obtaining portion 6, and performs an authentication. At this time, when the authentication is performed by use of the biometric characteristic data, it takes less time than the authentication of a standard level, because the authentication level is set to low. If a given period of time has passed since the authentication level was set to low (step S64/YES), the authentication processing ECU 7 returns the authentication level to the standard level (step S65), and processing ends. If a given period of time has not passed since the authentication level was set to low (step S64/NO), processing goes back to step S54.

### Fifth Exemplary Embodiment

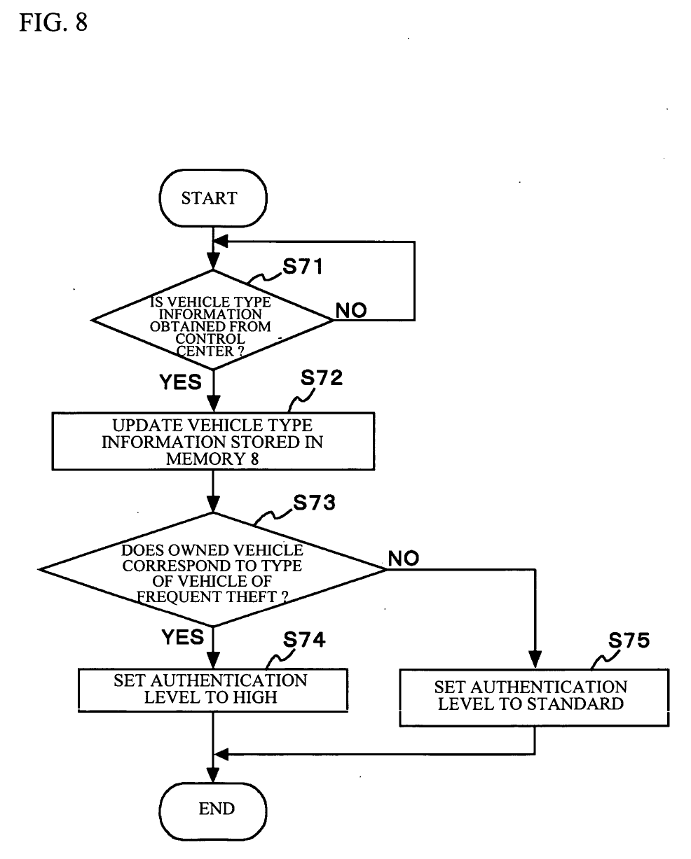

A fifth exemplary embodiment of the present invention will be described with reference to accompanying drawings. In the present exemplary embodiment, theft information delivered from a control center at every given period of time is obtained. If it is determined that the type of the owned vehicle is a target of frequent theft, the authentication level is set to high. FIG. 8 is a flowchart of the procedure in accordance with the fifth exemplary embodiment of the present invention. In the control center, not shown, the information on the vehicle type with the number of cases of theft is gathered and registered. The navigation device 9 is equipped with a wireless communication portion, which accesses a server device of the control center connected to a network at every given period of time, that is, at least one of once every half a year or every year, at every period of time set by a user, at every period of time desired by a user, and at the activation of the navigation device 9, in order to obtain the information on the vehicle type of the target of frequent theft from the above-described server device (step S71). If the navigation device 9 obtains the information on the vehicle type of frequent theft (step S71/YES), the navigation device 9 outputs the information to the authentication processing ECU 7. The authentication processing ECU 7 stores the vehicle type of frequent theft in the memory 8 (step S72). Next, the authentication processing ECU 7 checks the information on the vehicle thereof stored in the memory 8 and the information on the vehicle type of frequent theft, and determines whether or not the vehicle thereof corresponds to the vehicle type of frequent theft (step S73). If it is determined that the vehicle thereof corresponds to the vehicle type of frequent theft (step S73/YES), the authentication level by use of the biometric characteristic information is set to high to enhance the security (step S74). If the vehicle thereof does not correspond to the vehicle type of frequent theft (step S73/NO), the authentication level is set to the standard level (step S75). Then, the above-described processes are performed every time the navigation device 9 accesses the control center.

In accordance with the present exemplary embodiment, it is possible to avoid the occurrence of theft effectively, by heightening the authentication level of the vehicle type of frequent theft.

In the present exemplary embodiment, a description has been given of a case where the navigation device 9 accesses the control center to obtain the information on the vehicle type of frequent theft. However, the present invention is not limited thereto. The present invention is applicable to any case, if the information on the vehicle type of, for example, frequent theft is obtainable.

### Sixth Exemplary Embodiment

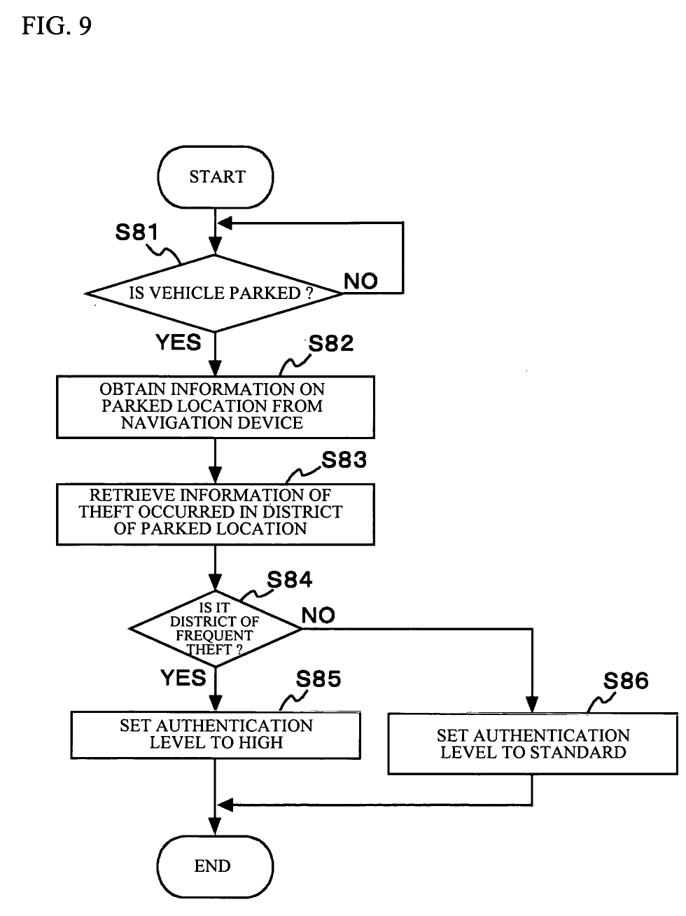

A sixth exemplary embodiment of the present invention will be described with reference to accompanying drawings. In the present exemplary embodiment, information on the district where a robbery or theft frequently occurs is obtained from the server device of the control center to set the authentication level according to the location of the parked vehicle. FIG. 9 is a flowchart of the procedure in accordance with the sixth exemplary embodiment of the present invention. The authentication apparatus for use in vehicle employed in the present exemplary embodiment performs the following processes, while the driver is parking the vehicle, for example, when the vehicle stops and a given period of time has passed.

When the IG detecting circuit 13 detects that the ignition key is turned off, it is determined that the vehicle is parked (step S81/YES). The authentication processing ECU 7 obtains the information on the current location from the navigation device 9 (step S82). The navigation device 9 identifies the current location of the vehicle by use of the GPS receiver that measures the absolute location of the vehicle or multiple independent navigation sensors mounted on the vehicle to notify to the authentication processing ECU 7 (step S82). Next, the authentication processing ECU 7 retrieves the theft information registered in the memory 8 in advance (step S83), and determines whether or not the currently parked location is included in the district of frequent theft (step S84). The theft information is obtained from the server device of the control center at every given period of time, by use of the wireless communication portion provided in the navigation device 9, as described in the fifth exemplary embodiment. If the currently parked location is included in the district of frequent theft (step S84/YES), the authentication processing ECU 7 sets the authentication level to high (step S85). If the currently parked location is included in the district of less frequent theft (step S84/NO), the authentication processing ECU 7 sets the authentication level to low (step S85).

### Seventh Exemplary Embodiment

A seventh exemplary embodiment of the present invention will be described with reference to accompanying drawings. In the present exemplary embodiment, an authentication is performed by use of at least two types of biometric information. In accordance with a matching rate of a first biometric authentication, the authentication levels of second or later biometric authentications may be changed. In the biometric authentication, biometric information such as vein, fingerprint, iris, face, or the like.

For example, a first biometric authentication is performed by use of a facial image captured by a camera provided inside or outside of the vehicle. In the authentication with the facial image, the authentication is performed by use of the image captured by a camera. This eliminates the necessity of passenger's key operation. In the authentication with the facial image, however, the recognition rate is varied by various factors such as glasses, bruise or scar, makeup, hairdo, and the like. In accordance with the authentication result of the facial image, the authentication level may be changed in second biometric authentication. In the second biometric authentication, biometric information such as vein, fingerprint, iris, face, or the like, which is obtainable inside or outside of the vehicle, may be used.

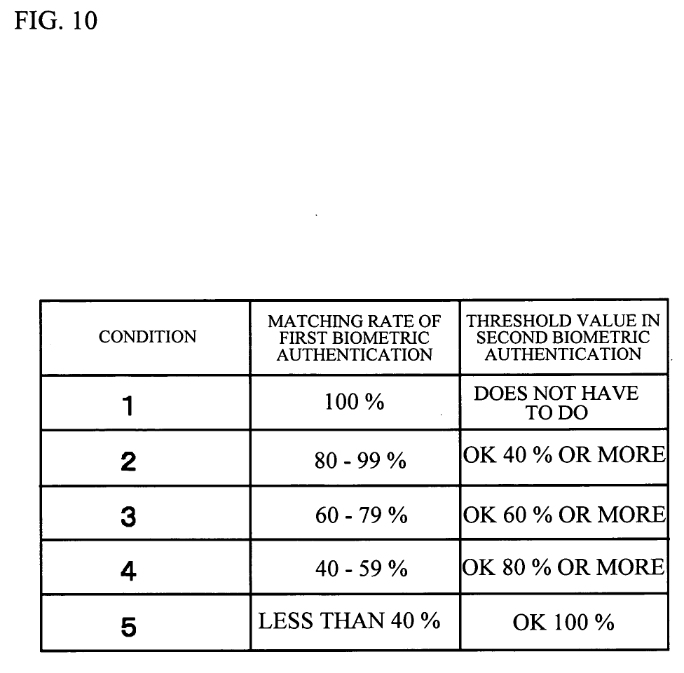

FIG. 10 shows an example in which the authentication level of the second biometric authentication is changed in accordance with the matching rate of the first biometric authentication. In the example of FIG. 10, if 100% is the matching rate in the first biometric authentication by use of the facial image, the second biometric authentication is not performed and, for example, a door is unlocked and engine start is allowed. If 80-99% is the matching rate in the first biometric authentication by use of the facial image, the second biometric authentication is performed, and if 40% or more is the matching rate in the second biometric authentication, the authentication success is determined. In a similar manner, if 60-79% is the matching rate in the first biometric authentication by use of the facial image, the second biometric authentication is performed and if 60% or more is the matching rate in the matching rate in the second biometric authentication, the authentication success is determined. In this manner, in accordance with the authentication result in the first biometric authentication, the authentication level is changed in the second biometric authentication.

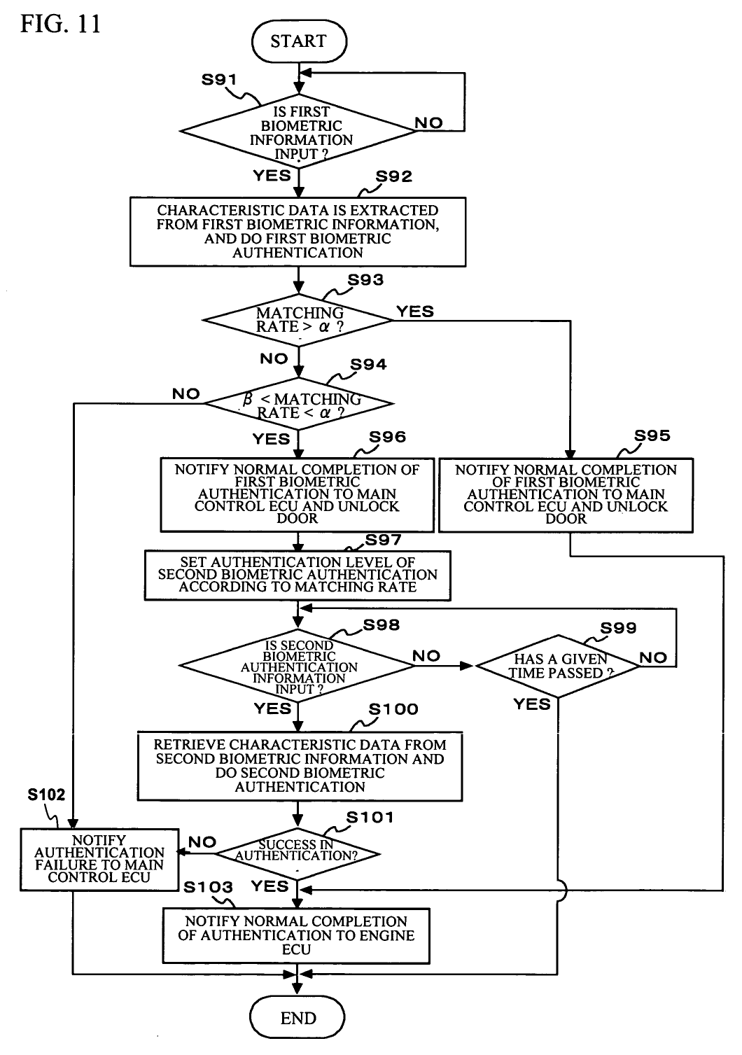

Next, a procedure employed in the present exemplary embodiment will be described with reference to a flowchart shown in FIG. 11. In the authentication apparatus for use in vehicle employed in the present exemplary embodiment, it is assumed that the biometric authentication information obtaining portion 6 is provided outside of the vehicle, for example at a door handle portion or the like. When it is detected that someone is approaching the vehicle by use of a smart key system or the like, when the passenger gets on the vehicle, or when the vehicle is unlocked and a passenger detecting sensor detects that the passenger sits on a seat, the authentication apparatus for use in vehicle employed in the present exemplary embodiment starts the following processes.

The first biometric information is supplied from the biometric authentication information obtaining portion 6 (step S91). The biometric characteristic data is extracted from the biometric information, and the first biometric authentication is performed at the authentication processing ECU 7 (step S92). The authentication processing ECU 7 checks and authenticates the biometric characteristic data registered in the memory 8 in advance and the biometric characteristic data obtained from the biometric authentication information obtaining portion 6. If the matching rate of the biometric characteristic data is equal to or more than a first reference value a (step S93/YES), the authentication processing ECU 7 notifies the authentication success to a main control ECU that controls the whole vehicle. The main control ECU that receives the authentication success notification controls the door to be unlocked (step S95). If the matching rate of the biometric characteristic data is equal to or more than a given value α (step S93/YES), the authentication processing ECU 7 notifies to the engine ECU 17 that the first biometric authentication is successful to allow the engine to start without performing the second biometric authentication (step S103).

If the matching rate of the biometric characteristic data is between a second reference value β and the first reference value α, namely, β<matching rate<α (step S94/YES), the authentication processing ECU 7 notifies the authentication success to the main control ECU that controls the whole vehicle to unlock the door. Here, the second reference value β is smaller than the first reference value α.

Also, the authentication processing ECU 7 sets the authentication level in the second biometric authentication in accordance with the matching rate of the first biometric authentication (step S97). The authentication processing ECU 7 waits for the second biometric information input from the biometric authentication information obtaining portion 6. If the biometric characteristic data of the second biometric information is obtained from the authentication information obtaining portion 6 (step S98), the authentication processing ECU 7 checks and authenticates the biometric characteristic data stored in the memory 8 in advance and the biometric characteristic data obtained from the biometric authentication information obtaining portion 6 (step S100). If the matching rate satisfies the authentication level set at step S97 (step S101/YES), the authentication processing ECU 7 determines the authentication success and notifies a normal completion of the second biometric authentication to the engine ECU 17 to allow the engine to start (step S103). If the second biometric information is not input from the biometric authentication information obtaining portion 6 after a give period of time has passed (step S99/YES), the procedure ends.

If the matching rate in the first biometric authentication is equal to or less than the second reference value β (step S94/NO), or if the matching rate of the biometric characteristic data in the second biometric authentication is equal to or less than a given value (step S101/NO), an authentication failure is notified to the main control ECU to disable the operation of the vehicle (step S102). After the door is unlocked, the first biometric authentication and the second biometric authentication may be performed, and if both authentications are successful, the engine may be enabled to start.

In the present exemplary embodiment, in accordance with the matching rate in the first biometric authentication, the authentication value in the second biometric authentication is changed. This makes it possible to shorten the time for authentication without lowering the authentication level.

In the above-described exemplary embodiments, a description has been given of a case where the identification is performed by the immobilizer ECU 4 by use of the identification information read from the vehicle key 1. However, the passenger may be made to carry an RFID tag so that the RFID reader 10 reads the identification information recorded in the tag. In addition, an ETC card may be used for identification. When the ETC card is inserted into an in-vehicle device, the authentication level may be set to low in the biometric authentication performed by the authentication processing ECU 7.

Furthermore, if a valet parking is carried out at a hotel or restaurant, the biometric authentication cannot be performed. For this case, specific places in which the biometric authentication is not performed may be designated by use of the operating portion of the navigation device 9.

Finally, various aspects of the present invention are summarized in the following.

According to one aspect of the present invention, there is provided an authentication method for use in a vehicle including: identifying validity by use of identification information stored; detecting an unauthorized use risk level predicted by a state of a vehicle; changing an authentication level according to an identification result and the unauthorized use risk level at the time of processing a biometric authentication; calculating a matching level between first biometric characteristic information of a vehicle passenger and second biometric characteristic information stored; and comparing the matching level calculated and an authentication level to output an authentication result at the time of processing the biometric authentication.

According to another aspect of the present invention, there is provided an authentication apparatus for use in a vehicle including: an identifying portion that identifies validity by use of identification information stored in a memory portion; an unauthorized use risk level detecting portion that detects an unauthorized use risk level predicted by a state of a vehicle; an authentication level changing portion that changes an authentication level according to an identification result of the identifying portion and the unauthorized use risk level detected by the unauthorized use risk level detecting portion at the time of processing a biometric authentication; a matching level calculating portion that calculates a matching level between first biometric characteristic information of a vehicle passenger and second biometric characteristic information stored in the memory portion; and a comparing portion that compares the matching level calculated by the matching level calculating portion and the authentication level to output an authentication result.

In the above-described authentication apparatus, the unauthorized use risk level may be different according to a time of a day. When the risk of robbery or theft is low, the authentication level may be set to low to shorten the time for authentication.

In the above-described authentication apparatus, the unauthorized use risk level may be determined by storing a frequency of an authentication on a time basis. Accordingly, it is possible to set the authentication level automatically on the basis of the authentication frequency.

In the above-described authentication apparatus, the unauthorized use risk level may be determined by a type of the vehicle. The authentication level can be set to high to the type of the vehicle of a high frequency of theft. The authentication level can be set to low to the type of the vehicle of a low frequency of theft, thereby making it possible to shorten the time for authentication.

In the above-described authentication apparatus, the unauthorized use risk level may be determined by a district of a current location of the vehicle. The authentication level can be set to high in the district of a high frequency of theft. The authentication level can be set to low in the district of a low frequency of theft, thereby making it possible to shorten the time for authentication.

The above-described authentication apparatus may further include an alarm portion that outputs an alarm when an unauthorized use may be found, and the unauthorized use risk level may be determined by an elapsed time since the alarm portion outputs the alarm. By changing the authentication level after the alarm operates, making it possible to protect the vehicle from robbery or theft.

The above-described authentication apparatus may further include a get-in and get-out detecting portion that detects that the vehicle passenger gets in or gets out of the vehicle, and the unauthorized use risk level may be determined by an elapsed time since the get-in and get-out detecting portion detects that the vehicle passenger gets out of the vehicle. There is high possibility that the passenger gets in the vehicle again within a given period of time after the passenger gets out of the vehicle. By changing the authentication level, the time for authentication can be shortened.

Although a few specific exemplary embodiments employed in the present invention have been shown and described, it would be appreciated by those skilled in the art that changes may be made in these exemplary embodiments without departing from the principles and spirit of the invention, the scope of which is defined in the claims and their equivalents.

The present invention is based on Japanese Patent Application No. 2005-342969 filed on Nov. 28, 2005, the entire disclosure of which is hereby incorporated by reference.

What is claimed is:

1. An authentication method for use in a vehicle comprises:
identifying validity by use of identification information stored;
detecting an unauthorized use risk level predicted by a state of a vehicle;
changing an authentication level according to an identification result and the unauthorized use risk level at the time of processing a biometric authentication;
calculating a matching level between first biometric characteristic information of a vehicle passenger and second biometric characteristic information stored; and
comparing the matching level calculated and an authentication level to output an authentication result at the time of processing the biometric authentication.

2. An authentication apparatus for use in a vehicle comprises:
an identifying portion that identifies validity by use of identification information stored in a memory portion;
an unauthorized use risk level detecting portion that detects an unauthorized use risk level predicted by a state of a vehicle;
an authentication level changing portion that changes an authentication level according to an identification result of the identifying portion and the unauthorized use risk level detected by the unauthorized use risk level detecting portion at the time of processing a biometric authentication;
a matching level calculating portion that calculates a matching level between first biometric characteristic information of a vehicle passenger and second biometric characteristic information stored in the memory portion; and
a comparing portion that compares the matching level calculated by the matching level calculating portion and the authentication level to output an authentication result.

3. The authentication apparatus as claimed in claim 2, wherein the unauthorized use risk level is different according to a time of a day.

4. The authentication apparatus as claimed in claim 3, wherein the unauthorized use risk level is determined by storing a frequency of an authentication on a time basis.

5. The authentication apparatus as claimed in claim 2, wherein the unauthorized use risk level is determined by a type of the vehicle.

6. The authentication apparatus as claimed in claim 2, wherein the unauthorized use risk level is determined by a district of a current location of the vehicle.

7. The authentication apparatus as claimed in claim 2, further comprising an alarm portion that outputs an alarm when an unauthorized use is found, wherein the unauthorized use risk level is determined by an elapsed time since the alarm portion outputs the alarm.

8. The authentication apparatus as claimed in claim 2, further comprising a get-in and get-out detecting portion that detects that the vehicle passenger gets in or gets out of the vehicle,
wherein the unauthorized use risk level is determined by an elapsed time since the get-in and get-out detecting portion detects that the vehicle passenger gets out of the vehicle.
